(19) United States
(12) Patent Application Publication
(10) Pub. No.: US 2005/0179382 A1
(43) Pub. Date: Aug. 18, 2005

(54) Plasma display panel

(76) Inventor: Jeong-Nam Kim, Suwon-si (KR)

Correspondence Address: MCGUIREWOODS, LLP, 1750 TYSONS BLVD, SUITE 1800, MCLEAN, VA, 22102, US

(21) Appl. No.: 11/049,723

(22) Filed: Feb. 4, 2005

(30) Foreign Application Priority Data
Feb. 5, 2004 (KR) 10-2004-0007673

(51) Int. Cl. H01J 17/49

(52) U.S. Cl. 313/582; 313/586; 313/584

(57) ABSTRACT

The present invention provides a plasma display panel including a front substrate, a rear substrate, first and second display electrodes formed in parallel with each other on a surface of the front substrate facing the rear substrate, and an address electrode formed on a surface of the rear substrate facing the front substrate and along a direction intersecting the display electrodes. An electron-emission layer is formed in a vicinity of the display electrodes.

### CROSS REFERENCE TO RELATED APPLICATION

This application claims priority to and the benefit of Korean Patent Application No. 10-2004-0007673, filed on Feb. 5, 2004, which is hereby incorporated by reference for all purposes as if fully set forth herein.

### BACKGROUND OF THE INVENTION

1. Field of the Invention

The present invention relates to a plasma display panel, and in particular, to a plasma display panel having an electron-emission layer that may provide address discharges at a lower voltage, high speed driving and improved luminous efficiency.

2. Discussion of the Background

Generally, a plasma display panel (PDP) displays images using a gas discharge, and it may replace the cathode ray tube (CRT) due to its excellent display characteristics such as luminance, contrast, and viewing angle. Applying an alternating current (AC) or direct current (DC) voltage to the PDP's electrodes generates a gas discharge, which causes emission of ultraviolet rays that excite phosphors to emit visible light.

The conventional PDP comprises facing front and rear substrates.

Address electrodes, barrier ribs and a phosphor layer may be formed on the rear substrate, and display electrodes, consisting of scan electrodes and sustain electrodes, may be formed on the front substrate. Applying an address voltage to the scan and address electrodes generates an address discharge between them. Applying a sustain voltage to the sustain and scan electrodes generates a sustain discharge between them. The scan electrode and the sustain electrode may each comprise a transparent electrode and a metal bus electrode. The transparent electrode may be made of indium tin oxide (ITO) or other like materials, and the metal bus electrode increases the transparent electrode's conductance.

A rear dielectric layer and a front dielectric layer may cover the address electrodes and the display electrodes, respectively. A portion of a discharge space between the front and rear substrates, where an address electrode crosses with a display electrode pair, defines one discharge cell, which may be filled with a discharge gas (typically a Ne—Xe gas mixture).

When applying the address voltage between the address electrode and the scan electrode, the address discharge occurs within the discharge cell to accumulate positive and negative charges, i.e. wall charge, on the front dielectric layer surfaces over the scan electrode and the sustain electrode, respectively. A wall voltage is the voltage across the space between the scan electrode and the sustain electrode. The discharge cell to be emitted is selected by the generation of the wall charges.

When applying the sustain pulse to the sustain electrode and the scan electrode of the selected discharge cell, the sustain discharge commences because the sustain pulse voltage plus the wall voltage is greater than the voltage required for plasma discharge. Then, vacuum ultraviolet rays, which are emitted from excited Xe atoms during the plasma discharge, excite the phosphor layer to emit visible light to display images.

A reset period may be included before the address period to erase wall charges in the discharge cells that were previously sustain discharged. During a conventional PDP's reset period, positive charges may accumulate on the surface of the rear dielectric layer over the address electrode, and negative charges may accumulate on the surface of the front dielectric layer over the scan electrode. This wall charge state may facilitate a following address discharge.

In a PDP described above, using lower barrier ribs may decrease the voltage required for the address discharge between the address and scan electrodes. However, shorter barrier ribs decrease the area covered with the phosphor layer and the amount of discharge space, thereby lowering the PDP's luminous efficiency.

### SUMMARY OF THE INVENTION

The present invention provides a PDP in which an address discharge may occur at a low voltage while still maintaining a high driving speed and luminous efficiency.

Additional features of the invention will be set forth in the description which follows, and in part will be apparent from the description, or may be learned by practice of the invention.

The present invention discloses a PDP including a front substrate, a rear substrate, display electrodes comprising a first display electrode and a second display electrode formed in parallel with each other on the front substrate and an address electrode formed on the rear substrate and along a direction intersecting the display electrodes. A first electron-emission layer is formed in a vicinity of the display electrodes.

The present invention also discloses a PDP including a front substrate, a rear substrate, display electrodes formed in parallel with each other on the front substrate, and an address electrode formed on the rear substrate and along a direction intersecting the display electrodes. An electron-emission layer is formed in a vicinity of the address electrode.

The present invention also discloses a plasma display panel (PDP) comprising a discharge cell, a first electrode, a second electrode, a first dielectric layer covering the first electrode, and a second dielectric layer covering the second electrode, and an electron-emission layer in the discharge cell. An address discharge occurs between the first electrode and the second electrode to select the discharge cell.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded partial perspective view showing a PDP according to a first exemplary embodiment of the present invention.

FIG. 2 is a cross-sectional view taken along line II-II of FIG. 1.

FIG. 3 is a partial cross-sectional view showing a PDP according to a second exemplary embodiment of the present invention.

FIG. 4 is a driving waveform that may be applied to electrodes of the PDP according to exemplary embodiments of the present invention.

FIG. 5A, FIG. 5B, FIG. 5C, FIG. 5D and FIG. 5E show wall charge distributions corresponding to periods A1, A2, A3, A4 and A5 of FIG. 4, respectively.

### DETAILED DESCRIPTION OF THE ILLUSTRATED EMBODIMENTS

Hereinafter, exemplary embodiments of the present invention will be described in detail with reference to the accompanying drawings.

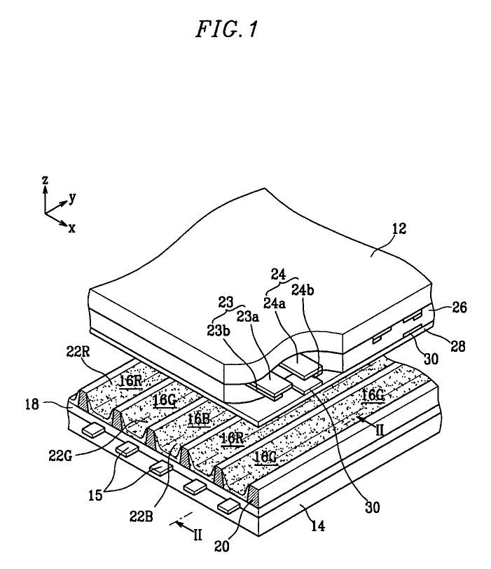

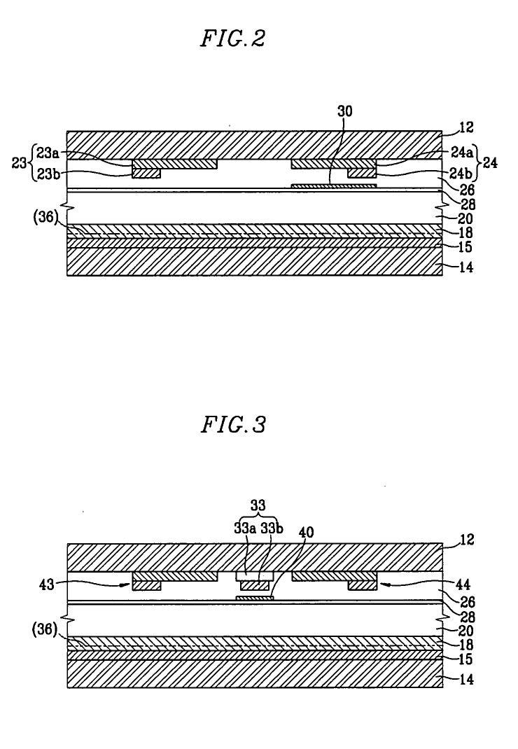

FIG. 1 is an exploded partial perspective view showing a PDP according to a first exemplary embodiment of the present invention, and FIG. 2 is a cross-sectional view taken along line II-II of FIG. 1.

Referring to FIG. 1 and FIG. 2, the PDP may include parallel front and rear substrates 12 and 14 having a gap between them, and discharge cells 16R, 16G, 16B in the gap. Each discharge cell 16R, 16G, 16B may produce a predetermined color by emitting visible light during a sustain discharge.

More specifically, address electrodes 15 may be formed along a direction (y-direction in FIG. 1) on an inner surface of the rear substrate 14 facing the front substrate 12. A rear dielectric layer 18 may cover the address electrodes 15. The address electrodes 15 may be positioned in various patterns, including a stripe pattern as shown in FIG. 1.

Barrier ribs 20 may be formed on the rear dielectric layer 18, and they may be arranged parallel to the address electrodes 15. Red, green and blue phosphor layers 22R, 22G, 22B may be sequentially formed on the rear dielectric layer 18 and the sides of the barrier ribs 20. The barrier ribs 20 are not limited to the stripe pattern as they may be formed in various patterns.

Display electrodes 23, 24 may be formed on an inner surface of the front substrate 12 facing the rear substrate 14, and they may comprise sustain electrodes 23 and scan electrodes 24 arranged orthogonally (x-direction in FIG. 1) to the address electrodes 15. A front dielectric layer 26 may cover the display electrodes 23, 24, and a protective layer 28 may cover the front dielectric layer.

The sustain electrodes 23 and the scan electrodes 24 may comprise striped transparent electrodes 23a, 24a and bus electrodes 23b, 24b, which increase the transparent electrodes' conductance and are positioned along an edge of the transparent electrodes. The transparent electrodes 23a, 24a may be made of ITO or other like materials, and the bus electrodes 23b, 24b may be made of Ag, a compound of Cr and Cu, or other like materials.

The protective layer 28 may be made of at least one material selected from a group including MgO, MgF₂, CaF₂, LiF, Al₂O₃, ZnO, CaO, SrO, SiO₂ and La₂O₃.

An electron-emission layer 30 may be positioned below the scan electrodes 24 and between the front dielectric layer 26 and the protective layer 28 or it may be positioned within the front dielectric layer 26. The electron-emission layer 30, which may allow the address discharge to occur at a low voltage and a high driving speed, emits electrons when the address voltage is applied between an address electrode 15 and a scan electrode 24.

The electron-emission layer 30 may be made of a carbon-based material such as carbon nanotube, diamond-like carbon and graphite. It may also be made of one or more materials selected from a group including carbonate, barium and rare-earth metals.

Portions of a discharge space between the front and rear substrates, where the address electrode 15 crosses the display electrodes 23, 24, define discharge cells 16R, 16G, 16B, which may be filled with a discharge gas (typically a Ne—Xe gas mixture).

Applying an address voltage between the address electrode 15 and the scan electrode 24 of the red discharge cell 16R generates an address discharge in the cell. This discharge may accumulate positive charges and negative charges on surfaces of the front dielectric layer 26 on the sustain electrode 23 and the scan electrode 24, respectively, thereby selecting the discharge cell 16R.

However, since the electron-emission layer 30 may be positioned below the scan electrode 24, it may emit electrons during the address discharge.

Therefore, the address discharge may occur at a low voltage, and a high driving speed may be possible due to a shortened delay time.

Thus, the electron-emission layer may provide a low-voltage address discharge without decreasing barrier rib height. Therefore, the discharge space and luminous efficiency are not decreased.

When alternately applying the sustain pulse to the sustain electrode 23 and the scan electrode 24 of the selected discharge cell 16R, the wall charges accumulated on the surface of the front dielectric layer 26 collide with each other to cause a plasma discharge, i.e., sustain discharge. The sustain discharge may begin in the discharge gap between the sustain and scan electrodes, and it propagates to both ends of the discharge cell. Vacuum ultraviolet rays emit from excited Xe atoms during the plasma discharge to excite the phosphor layer to emit visible light for displaying images.

As illustrated in a two-dot chain line of FIG. 2, an electron-emission layer 36 may be formed near the address electrode 15. In other words, the electron-emission layer 30 may be formed within the front dielectric layer 26 near the scan electrode 24, or the electron-emission layer 36 may be formed within the rear dielectric layer 18 near the address electrode 15. Alternatively, both electron-emission layers 30, 36 may be simultaneously included within the PDP on both the front substrate and the rear substrate.

Also, the electron-emission layer 30 or the electron-emission layer 36 may be formed directly on the scan electrode 24 or on the address electrode 15, respectively. This may be achieved by coating the surface of each electrode with the electron-emission material.

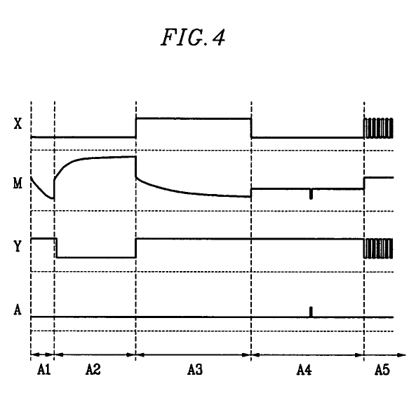

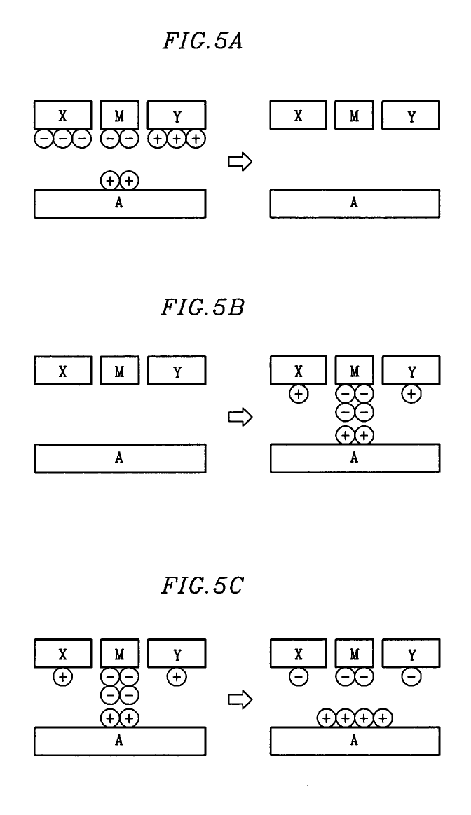

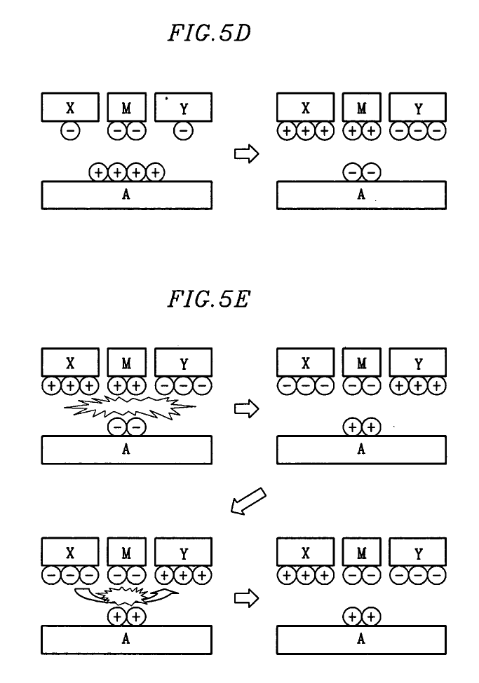

FIG. 3 is a partial cross-sectional view showing a PDP according to a second exemplary embodiment of the present invention. FIG. 4 is a driving waveform that may be applied to each electrode of the PDP. FIG. 5A, FIG. 5B, FIG. 5C, FIG. 5D and FIG. 5E show wall charge distributions corresponding to periods A1, A2, A3, A4 and A5 of FIG. 4, respectively.

Differences between the first and second exemplary embodiments include a middle electrode 33 between a sustain electrode 43 and a scan electrode 44, and the address discharge occurs between the address electrode 15 and the middle electrode 33.

Hereinafter, the same reference number refers to the same component of the first exemplary embodiment, and further detailed description is omitted.

As shown in FIG. 3, the display electrodes of the second exemplary embodiment may include the middle electrode 33 between a pair of display electrodes 43, 44. The middle electrode 33 may have a transparent electrode 33a and a bus electrode 33b to enhance the transparent electrode's conductance. However, the middle electrode 33 may comprise either the transparent electrode 33a or the bus electrode 33b.

An electron-emission layer 40 may be below the middle electrode 33 and between the front dielectric layer 26 and the protective layer 28 or within the front dielectric layer 26. The electron-emission layer 40 may provide an address discharge at a low voltage and a high driving speed by emitting electrons when the address voltage is applied between the address electrode 15 and the middle electrode 33.

As illustrated in a two-dot chain line of FIG. 3, the electron-emission layer 36 may be formed near the address electrode 15. In other words, the electron-emission layer 40 may be formed within the front dielectric layer 26 near the middle electrode 33, or the electron-emission layer 36 may be formed within the rear dielectric layer 18 near the address electrode 15. Alternatively, the electron-emission layers 40, 36 may be simultaneously included within the PDP.

Also, the electron-emission layer 40 or the electron-emission layer 36 may be formed directly on the middle electrode 33 or on the address electrode 15, respectively. This may be achieved by coating the surface of each electrode with the electron-emission material.

The address discharge may occur between the middle electrode 33 and the address electrode 15, as explained with reference to FIG. 4 and FIG. 5. In FIG. 4 and FIG. 5, the display electrode pair 43, 44 are shown as X and Y, respectively, and the middle electrode 33 and the address electrode 15 are shown as M and A, respectively.

FIG. 4 shows driving waveforms that may be applied to the X, M, Y and A electrodes. In the drawing, the abscissa and the ordinate represent time and voltage level, respectively.

Applying the driving waveforms in the first period A1 of FIG. 4 to each electrode may erase wall charges remaining from the just-finished sustain discharge (see FIG. 5A). Applying the driving waveforms in the second period A2 of FIG. 4 accumulates negative charges on the M electrode, which serves as the scan electrode, and positive charges on the X, Y, and A electrodes. (see FIG. 5B).

Next, in the third period A3 of FIG. 4, the charges on each electrode may be uniformly established in all panels cells to an appropriate amount (see FIG. 5C).

In the fourth period A4, pulses may be applied to the M and A electrodes, and a negative bias voltage and a positive bias voltage may be applied to the X and Y electrodes, respectively. Then, an address discharge occurs between the A and M electrodes and propagates. Consequently, positive charges accumulate on the X and M electrodes, and negative charges accumulate on the Y and A electrodes. (see FIG. 5D).

Next, in the fifth period A5, the sustain discharge may occur between the X, M and Y electrodes due to the positive pulse at the M electrode, in spite of the positive pulse at the X electrode and the negative pulse at the Y electrode.

Since a constant voltage may be applied to the M electrode during the sustain discharge of the fifth period A5 after the first sustain discharge pulse, the M electrode's contribution to the sustain discharge decreases. Therefore, the main sustain discharge may occur between the X and Y electrodes, and the number of pulses determines the displayed images.

The upper, left figure of FIG. 5E shows the discharge by the first sustain pulse (between the X, M and Y electrodes). The upper right and lower left figures of FIG. 5E show wall charge distributions after the first sustain discharge and the second sustain discharge (between the X and Y electrodes), respectively. The lower right figure shows wall charge distributions after the second sustain discharges. The negative wall charges are continuously accumulated at the M electrode, and the negative wall charges and the positive wall charges are alternately accumulated to the X and Y electrodes in the fifth period A5.

When driving the PDP as explained above, particularly with applying the pulse to the M and A electrodes for the address discharge, the electron-emission layer 40 below the M electrode emits electrons, thereby permitting the low voltage address discharge.

While exemplary embodiments of the present invention have been explained in relation to surface discharge PDPs of the 3-electrode type (an X electrode, a Y electrode and an address electrode) and 4-electrode type (an X electrode, a Y electrode, a middle electrode and an address electrode), the present invention is not limited to these embodiments.

The electron-emission layer may be placed in the vicinity of the scan electrode and/or the vicinity of the address electrode in any PDP where driving voltages are applied for the address discharge.

In a PDP according to exemplary embodiments of the present invention as described above, the address discharge may occur at a low voltage due to electrons from the electron-emission layer, and a shortened delay time leads to high speed driving.

Also, since the electron-emission layer permits the low voltage address discharge, barrier rib height does not need to be decreased, which preserves the amount of discharge space and prevents lower luminous efficiency.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a front substrate;
a rear substrate;
display electrodes comprising a first display electrode and a second display electrode formed in parallel with each other on the front substrate;
an address electrode formed on the rear substrate and along a direction intersecting the display electrodes; and
a first electron-emission layer formed in a vicinity of the display electrodes.

2. The PDP of claim 1, further comprising:
a dielectric layer covering the display electrodes,
wherein the first electron-emission layer contacts the dielectric layer.

3. The PDP of claim 1, wherein the first electron-emission layer is formed on a surface of a display electrode.

4. The PDP of claim 1, further comprising a protective layer covering the first electron-emission layer.

5. The PDP of claim 4, wherein the protective layer comprises MgO, MgF₂, CaF₂, LiF, Al₂O₃, ZnO, CaO, SrO, SiO₂ or La₂O₃.

6. The PDP of claim 1, wherein the first electron-emission layer comprises carbonate, barium, a rare-earth metal, or a carbon-based material.

7. The PDP of claim 6, wherein the carbon based material is carbon nanotube, diamond-like carbon or graphite.

8. The PDP of claim 1,
wherein the first display electrode is a scan electrode and the second display electrode is a sustain electrode; and
wherein the first electron-emission layer is formed in a vicinity of the scan electrode.

9. The PDP of claim 1, wherein the display electrodes further comprise a third display electrode located between the first display electrode and the second display electrode, and
wherein the first electron-emission layer is formed in a vicinity of the third electrode.

10. The PDP of claim 1, further comprising a second electron-emission layer formed in a vicinity of the address electrode.

11. A plasma display panel (PDP), comprising:
a front substrate;
a rear substrate;
display electrodes formed in parallel with each other on the front substrate;
an address electrode formed on the rear substrate and along a direction intersecting the display electrodes; and
an electron-emission layer formed in a vicinity of the address electrode.

12. The PDP of claim 11, further comprising:
a dielectric layer covering the address electrode,
wherein the electron-emission layer contacts the dielectric layer.

13. The PDP of claim 11, wherein the electron-emission layer is formed on a surface of the address electrode.

14. The PDP of claim 11, wherein the electron-emission layer comprises carbonate, barium, a rare-earth metal, or a carbon-based material.

15. The PDP of claim 14, wherein the carbon based material is carbon nanotube, diamond-like carbon or graphite.

16. A plasma display panel (PDP), comprising:
a discharge cell;
a first electrode;
a second electrode;
a first dielectric layer covering the first electrode;
a second dielectric layer covering the second electrode; and
an electron-emission layer in the discharge cell,
wherein an address discharge occurs between the first electrode and the second electrode to select the discharge cell.

17. The PDP of claim 16, wherein the electron-emission layer contacts the first dielectric layer.

18. The PDP of claim 16, wherein the electron-emission layer contacts the second dielectric layer.

19. The PDP of claim 16, wherein the electron-emission layer is formed on at least one of the first electrode and the second electrode.

20. The PDP of claim 16, wherein the electron-emission layer comprises carbonate, barium, a rare-earth metal, or a carbon-based material.

21. The PDP of claim 20, wherein the carbon based material is carbon nanotube, diamond-like carbon or graphite.
